(19) United States
(12) Patent Application Publication
(10) Pub. No.: US 2021/0255067 A1
(43) Pub. Date: Aug. 19, 2021

(54) SYSTEM AND METHOD FOR LIQUID DISPLACEMENT AUTO-SAMPLING

(71) Applicant: Insight Analytical Solutions Inc., Calgary (CA)

(72) Inventors: Kurt Trefiak, Edgerton, Alberta (CA); Philip C. Harris, Calgary, Alberta (CA)

(21) Appl. No.: 17/049,274

(22) PCT Filed: Apr. 23, 2019
(86) PCT No.: PCT/CA2019/050511

§ 371 Date: Oct. 20, 2020

Related U.S. Application Data
(60) Provisional application No. 62/661,375, filed on Apr. 23, 2018.

(51) Int. Cl. G01N 1/20; G01N 1/22

(52) U.S. Cl. CPC G01N 1/2035; G01F 23/30; G01N 2001/205; G01N 1/2247

(57) ABSTRACT

A system and method for accurate, automated collection of a sample of a process fluid flowing through a transport line includes: a first container for collecting the sample and being pre-filled with a displacement fluid immiscible with the process fluid; a second container having smaller volume than the volume of the first container, for collecting the displacement fluid; an actuated valve positioned between the first container and the second container and actuated by a controller to move from an open position to initiate collection of the sample in the first container and transfer the process fluid displaced from the first container into the second container, and to move the actuated valve to the closed position upon receiving a signal from the fluid level sensor regarding level of fluid in the second container.

### FIELD OF THE INVENTION

The present invention pertains to the field of collecting samples from process fluid streams. In particular the invention relates to a system and method for automated collection of a sample from a process fluid stream, such as a hydrocarbon sample for analysis.

### BACKGROUND OF THE INVENTION

Conventional sampling methods typically involve manual collection using various sample collection vessels. However, manual operations have been found to prove challenging in remote sites, and continuous processes may require sampling beyond normal working hours. Further, manual systems are subject to an operator potentially manipulating the fill sequence differently each time, thereby negatively affecting the quality of the sample. In the event that the operator becomes incapacitated or is unable to shut off the process fluid valve, there is a risk that fluid may leak or spill, increasing the likelihood of operator contact with hazardous fluid, worksite and environmental contamination, subsequent spill clean-up and its associated costs, and halting of operations.

Automated systems have been developed in attempt to replace manual operations. One system involves use of an expensive, heavy floating piston cylinder within which the sample fluid is entirely contained under all conditions, since the piston prevents the fluid from escaping even when overfilled. A disadvantage of the floating piston cylinder is the requirement for a gas phase pressurized fluid on the “pre-charge” side of the piston. When the sample is isolated from the process, the system must have not only a first valve that closes in the clean vent fluid, but also a second valve in the dirty process fluid since the pressurized gas is expandable and acts as a spring. If the process pressure drops, the collected sample within the cylinder is pushed back into the process and the sample is altered. The addition of the second valve also makes the internal volume between the process and the cylinder much greater, and typically requires a continuous sweep through the head of the cylinder to ensure that the sample is not contaminated with stale fluid that was trapped in the dead leg. The continuous sweep is a feasible option, but requires additional hardware; for example, a differential pressure or diversion valve to push the sample through the restrictive tubing and fittings, and an expensive flow meter to ensure that the sample is not plugged off or to determine if a valve is not positioned correctly.

Another disadvantage of the floating piston cylinder is that it is dependent on three variables to determine when the cylinder will begin filling, and consequently requires position switches to determine the location of the piston at the empty and full positions. The three variables are the pre-charge pressure in the cylinder, the process pressure, and the bleed rate of the inert gas from the pre-charge cylinder, all of which affect the delay between the fluid path to the cylinder opening and the beginning of the fill. This makes the floating piston cylinder an inadequate tool where precise time stamping of the sample is required.

Another disadvantage is cost and availability of floating piston cylinders. Given their expense, these type of cylinders are often in short supply and as such many facilities are not able to pull as many samples as may be warranted.

Accordingly, there is a need for improved sampling systems and methods to mitigate the limitations of manual operations and automated systems utilizing floating piston cylinders.

This background information is provided for the purpose of making known information believed by the applicant to be of possible relevance to the present invention. No admission is necessarily intended, nor should be construed, that any of the preceding information constitutes prior art against the present invention.

### SUMMARY OF THE INVENTION

An object of the present invention is to provide a system and method for liquid displacement auto-sampling.

In accordance with an aspect of the present invention, there is provided a system for collection of a sample of a process fluid flowing through a transport line. The system comprises: a first container having an inlet and an outlet, the container being configured for a removable connection to the transport line to be in fluid communication therewith via the inlet, the first container being pre-filled with a displacement fluid immiscible with the process fluid; a second container having an inlet in fluid communication with the outlet of the first container via a connection line removably connected to the outlet of the first container; the second container having a smaller volume than a volume of the first container; a first sample inlet valve positioned between the inlet of the first container and the transport line, the sample inlet valve movable between a closed position and an open position; a flow restriction valve positioned in the connection line between the outlet of the first container and the inlet of the second container, the flow restriction valve movable between a closed position and an open position; a fluid level sensor configured to monitor a fluid level of the second container; a controller operatively connected to the sample inlet valve, the flow valve, and the fluid level sensor, wherein the controller being configured to actuate the sample inlet valve and the flow restriction valve to move into their respective open positions to allow collection of the sample in the first container and transfer of the displacement fluid from the first container into the second container, and to actuate the sample inlet valve and flow restriction valve back to their respective closed positions upon receiving a signal from the fluid level sensor when the second container is filled with the displacement fluid.

In accordance with an aspect of the present invention, there is provided a method for collection of a sample of a process fluid flowing through a transport line, comprising: providing a first container pre-filled with a displacement fluid immiscible with the sample; providing a second container having a smaller volume than the first container, and configured to be in fluid communication with first container; connecting the first container with the transport line; allowing the process fluid to enter the first container to displace the displacement fluid and transfer same to the second container; monitoring the level of the displacement fluid within the second container using a fluid level sensor, and stopping the flow of the process fluid into the first container and the flow of the displacement fluid into the second container upon receiving a signal from the fluid level sensor.

Additional aspects and advantages of the present invention will be apparent in view of the description, which follows.

### BRIEF DESCRIPTION OF THE DRAWINGS

The invention will now be described by way of an exemplary embodiment with reference to the accompanying simplified, diagrammatic, not-to-scale drawings. In the drawings:

FIG. 1 is a schematic depiction of the system in accordance with an embodiment of the present invention, prior to initializing the sampling process.

FIG. 2 is a schematic depiction of the system in accordance with an embodiment of the present invention, after collection of the sampling process.

### DETAILED DESCRIPTION

Unless defined otherwise, all technical and scientific terms used herein have the same meaning as commonly understood by one of ordinary skill in the art to which this invention belongs.

Where a range of values is provided, it is understood that each intervening value, to the tenth of the unit of the lower limit unless the context clearly dictates otherwise, between the upper and lower limit of that range and any other stated or intervening value in that stated range is encompassed within the invention. The upper and lower limits of these smaller ranges may independently be included in the smaller ranges is also encompassed within the invention, subject to any specifically excluded limit in the stated range. Where the stated range includes one or both of the limits, ranges excluding either or both of those included limits are also included in the invention.

As used herein, the term “sample” refers to a fluid (gas or liquid) to be collected for analysis. In one embodiment, the sample comprises a hydrocarbon-containing gas or liquid. As used herein, the term “hydrocarbon” broadly refers to any compound containing primarily carbon and hydrogen, and optionally one or more hetero atoms such as O, S, N, etc., and particularly occurring in petroleum, natural gas, natural gas liquids, coal, bitumen, condensate, crude oil, refined products, and the like.

As used herein, the term “clean” means pure or free of any contaminant. As used herein, the term “inert” means chemically inactive. As used herein, the term “immiscible” means incapable of forming a homogeneous mixture when combined. Suitable displacement fluids include, but are not limited to, glycol and water.

As used herein, the term “about” refers to a +/−10% variation from the nominal value. It is to be understood that such a variation is always included in a given value provided herein, whether or not it is specifically referred to.

The present invention relates to a system and method for accurate, unattended, automated collection of a sample from a process fluid stream, particularly a hydrocarbon sample for analysis.

The system/method of the present invention not only minimizes operator contact with the hazardous sample, but also minimizes the risks of a fluid leak or spill. The system also improves sampling repeatability as it can be triggered to fill at exactly the right time and will fill at the same rate repeatedly.

The present invention provides a system to automatically collect a sample of a process fluid flowing through a transport line. The system comprises a first container having an inlet and an outlet, and configured for a removable connection to the transport line to be in fluid communication therewith via the inlet. Prior to initializing the sample collection, the first container is pre-filled with a displacement fluid immiscible with the process fluid. The system also comprises a second container having an inlet in fluid communication with the outlet of the first container via a connection line, which is removably connected to the outlet of the first container. The second container has a smaller volume than a volume of the first container.

The system further comprises a sample inlet valve positioned between the inlet of the first container and the transport line, and configured to be selectively opened to allow the inflow of the sample, or closed to prevent the inflow of the sample.

An actuated/flow permission valve is positioned in the connection line between the outlet of the first container and the inlet of the second container. The actuated valve is movable between an position and a closed position to allow or stop the flow of the displacement fluid from the first container to the second container.

The system further comprises a fluid level sensor configured to monitor level of the displacement fluid in the second container, and a controller operatively connected to the sample inlet valve, the flow valve, and the fluid level sensor. The controller is configured to actuate the sample inlet valve and the actuated valve to move into their respective open positions to allow collection of the sample in the first container and transfer of the displacement fluid from the first container into the second container, and to actuate the sample inlet valve and actuated valve back to their respective closed positions upon receiving a signal from the fluid level sensor when the second container is filled with the displacement fluid.

The method of operating the sample inlet valve and the actuated valve can be pneumatic, electric, magnetic or via other mechanical means.

In some embodiments, controller can be programmed to open and close the sample inlet valve and the actuated valve to alternate between their respective closed position and open position for pre-defined intervals, while the second container is being filled with the displacement fluid. In some embodiments, the pre-defined time is about 2 to 6 minutes.

In some embodiments, the transport line is in fluid communication with the first container via a sample inlet line connected to the sample inlet valve. The sample inlet line can have a variable length so that the first container can be located at any desired distance away from the transport line.

The first container can be configured for fluid communication with the transport line or the sample inlet line via one or more removable connections, via suitable valve(s) and/suitable fittings.

The outlet of the first container can be detachably connected to the connection line, via a suitable fitting, such as quick-connect fitting.

The second container has a smaller volume than the volume of the first container, such that a portion of the displacement fluid remains in the first container after the second container is filled with the displacement fluid. In some embodiments, the second container has a volume limited to receive about 60% to about 80% of the displacement fluid from the first container. In some embodiments, the remaining portion of clean displacement fluid in the first container ranges from about 20% to about 40%.

In some embodiments, the first container has a volume of about 500 cc. In some embodiments, the second container has a volume of about 300 cc.

Prior to initializing the sampling, the first container is filled with a clean displacement fluid, which is inert and immiscible with the process fluid. In some embodiments, the displacement fluid is water. In some embodiments, the displacement fluid is glycol.

In some embodiments, the second container is maintained at or near atmospheric pressure and contains a gas such as air, nitrogen, natural gas, argon, and the like.

In some embodiments, the second container is maintained at or near atmospheric pressure and contains air.

The first and second container can have any shape and orientation. In some embodiments, the first container and/or the second container are cylinder-shaped. In some embodiments both of the first and second containers are cylinder shaped. In some embodiments, the cylinders are oriented vertically.

In some embodiments, the first container is a commonly available liquid displacement container which is less expensive and lighter than conventional floating piston containers.

In some embodiments, the actuated valve is biased in the closed position, for example, via a spring which ensures positive shutoff.

In some embodiments, the fluid level sensor comprises a level switch, a pressure sensor, a differential pressure transducer, or a pressure switch. In some embodiments, the fluid level sensor is a level switch positioned above the second container.

The connections between the controller and the sample inlet valve, actuated valve and the fluid level sensor can be independently wired, wireless or a combination of wired or wireless connections.

The operative connection lines for fluid communication between respective components for conveying the sample or displacement fluid therebetween, can be tubes, pipes, hoses, and the like, or a combination thereof.

In some embodiments, the first container further comprises a secondary sample inlet valve positioned between the first sample inlet valve and the inlet of the first container, and is movable between a closed position and an open position. In some embodiments, the secondary sample inlet valve is positioned along the sample inlet line. In some embodiments, the secondary sample inlet is connected to or integral with the first container.

In some embodiments, the first container further comprises an outlet valve in communication with the outlet of the first container and a connection line. In some embodiments, the outlet valve is positioned along the connection line between the first container and the second container. In some embodiments, the outlet valve is connected to or integral with the first container. The outlet valve can be detachably connected to the connection line, via a suitable fitting, such as quick-connect fitting.

The secondary sample inlet valve and the outlet valve can be actuated manually or via a controller.

In some embodiments, the system further comprises a flow control device in fluid communication with the actuated valve and the outlet of the first container for controlling flow rate of the displacement fluid from the first container, and throttle the rate at which the sample flows into the first container. Non limiting examples of suitable flow control devices are a fixed orifice, a needle valve, or a metering valve.

The flow control device is chosen or set to allow a specific and repeatable flow rate, which is dependent on the size of the orifice of the flow control device and/or process pressure and/or properties of the fluid. Such settings help in ensuring that the first container is filled with process fluid at a pre-determined rate consistent with good sampling practices.

In some embodiments, the flow control device further comprises a locking member, such as a lock screw for setting after initial commissioning to ensure that tampering does not occur.

In some embodiments, the system further comprises an overflow backup subsystem in communication with the second container. In some embodiments, the overflow backup subsystem comprises a reservoir, a mechanical float comprising an air vent valve, or a combination thereof.

A mechanical float is provided to allow air/gas to vent freely into the atmosphere or into the reservoir via line during filling of the second container, thereby ensuring that the rate of displacement fluid fill remains steady.

Air/gas vent valve is provided to act as a backup shut off if a failure occurs with the controller, fluid level sensor, and/or the actuated valve. The air vent valve preferably is set to the open position. If the displacement fluid level reaches the mechanical float causing it to rise, the mechanical float subsequently closes the air vent valve to prevent escape of the displacement fluid.

The system further comprises a displacement fluid removal subsystem for removing the displacement fluid from the second container after collection of the sample in the first container.

In some embodiments, the displacement fluid removal subsystem comprises a drain line in communication with the second container via one or more drain valves, wherein the drain valves are independently movable between a closed position and an open position. The drain valve can be actuated manually and/or via controller.

In some embodiments, the displacement fluid removal subsystem comprises a drain line connected to a connection line between the first and second containers, via a three-way solenoid valve in order to direct the flow of the displacement fluid either into the second container or from the second container into a drain vessel through a second drain valve, as required.

In some embodiments, the drain vessel is a graduated container in order to measure the observed volume of the displacement fluid for comparison with the expected volume. Consistency between the observed and expected volumes indicates/ensures that the second container has been drained fully, the fluid level sensor is functioning properly, and an overflow of displacement fluid sufficient to raise the mechanical float did not occur.

In some embodiments, the displacement fluid removal subsystem comprises a pump for pumping the displacement fluid to a replaced first container. The pump enables the dead space above the first container to be purged with the displacement fluid, thereby ensuring that no contamination from the dead space occurred when the sample is taken.

In some embodiments, the first container may be equipped with a relief valve to protect against thermal expansion.

In some embodiments, the actuated valve and the sample inlet valve are biased into closed positions.

The sample inlet valves and the outlet valve of the first container and the actuated valve are configured to be selectively opened to allow the inflow of the sample, or closed to prevent the inflow of the sample.

Opening of the first sample inlet valve, and the secondary sample inlet valve (when present) enables inflow of the sample from the transport line, into the first container, and to displace the displacement fluid contained in the container due to its immiscibility with the process fluid. Opening of the actuated valve and the outlet valve (when present) enables the flow of the displaced displacement fluid from the first container to the second container.

Closure of the first sample inlet valve, and the actuated valve, along with the closure of the secondary sample inlet valve (when present) and the outlet valve (when present) enables shut down of the sample inlet line and safe, manual removal of the first container for analysis of the collected sample contained therein, thereby minimizing or avoiding sample loss, leakage, or spillage.

When the system is triggered to fill the first container with the sample, first sample inlet valve and the actuated valve, and if present, the secondary sample inlet valve and the outlet valve are opened to allow the flow of the displaced displacement fluid into the second container via the connection line(s) between the first and the second container. As the system involves flow of fluid, the pressures equalize immediately upon opening of the actuated valve and the sample begins flowing into the first container. Unlike prior art systems, the system eliminates the need for expensive flow and position detecting sensors.

Upon receipt of the signal from the level switch that the second container has reached its capacity for displacement fluid, the controller transmits a signal to the actuated valve and the sample inlet valve to close, preventing overflow of additional displacement fluid into the second container.

In some embodiments, the controller includes a programmable timer to determine whether the flow of displacement fluid into the second container and collection of the sample in the first container is progressing “normally” or as desired.

In some embodiments, when the controller is configured to actuate the sample inlet valve and actuated valve to alternate between their closed and open positions, while the second container is being filled, if the fluid level sensor does not detect any displacement fluid within a predetermined time (for example from about 2 to 10 minutes), an alarm is triggered to alert the operator.

In another aspect of the present invention, there is provided a method for collection of a sample of a process fluid flowing through a transport line. The method comprises the steps of providing a first container pre-filled with a displacement fluid immiscible with the process fluid, providing a second container having a smaller volume than the first container, and configured to be in fluid communication with first container, connecting the first container with the transport line, allowing the process fluid to enter the first container to displace the displacement fluid and transfer same to the second container, monitoring the level of the displacement fluid within the second container using a fluid level sensor, stopping the flow of the process fluid into the first container and the flow of the displacement fluid into the second container upon receiving a signal from the fluid level sensor.

In some embodiments, the method further comprises controlling a flow rate of the displacement fluid from the first container to the second container.

In some embodiments, the method further comprises comprising replacing the first container, and removing the displacement fluid from the second container.

In some embodiments, the method comprises intermittently stopping the flow of the process fluid and displacement fluid for a pre-defined internals prior to receiving signal from the fluid level sensor.

The present invention therefore provides improved system/method for accurate, unattended/automated collection of a sample from a process fluid stream, such as a hydrocarbon sample for analysis. The improved system/method of the present invention not only minimizes operator contact with the hazardous sample, but also minimizes the risks of a fluid leak or spill. The system also improves sampling repeatability as it can be triggered to fill at exactly the right time and will fill at the same rate repeatedly.

The remotely triggered system also improves safety as the system is configured to automatically shut down the escape of fluid in the event that the operator becomes incapacitated or is unable to shut off the sample inlet valve, or if failure occurs with the actuated valve, controller, or fluid level sensor. Shutdown is achieved using the overflow backup subsystem having an entirely different mode of operation. The air vent valve allows the air/gas to escape during filling to ensure that the rate of fill remains steady, and allows for the automatic introduction of vapor to fill the expanding volume as the process fluid is removed during drainage.

The system involves use of a clean, inert displacement fluid such as, water or glycol, thereby avoiding contamination or fouling which could cause leaks in the valves due to particulates (for example, sand or fine particulates) or restrict movement of the fluid level sensor due to coating by viscous wax or asphaltene-type material. Use of a clean, inert, immiscible process fluid may also minimize servicing, and maintenance.

To gain a better understanding of the invention described herein, the following examples are set forth. It will be understood that these examples are intended to describe illustrative embodiments of the invention and are not intended to limit the scope of the invention in any way.

### Examples

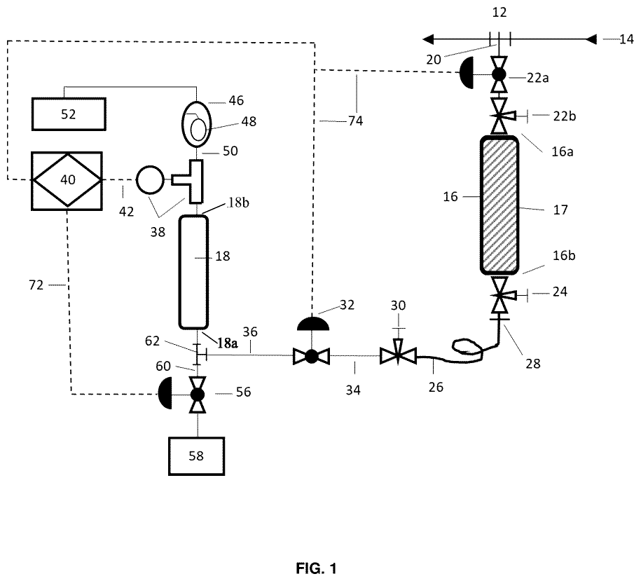

FIG. 1 is a schematic depiction of an embodiment of the system (10) of the present invention for the accurate, automated collection of a sample of a process fluid flowing through a transport line (14) prior to initializing the sampling process. The system (10) includes a first container/cylinder filled with a displacement fluid (17) and having an inlet (16a) and an outlet (16b), and the first cylinder is in fluid communication with an empty second container/cylinder (18) having an inlet (18a) and an outlet (18b).

The second cylinder has a smaller volume than the volume of the first cylinder, such that a portion of the displacement fluid remains in the first cylinder after the second cylinder is filled with the displacement fluid.

A sample inlet line (20) is in fluid communication with the transport line (14) and with the inlet (16a) of the first cylinder via a first sample inlet valve (22a) and a second inlet valve (22b), both configured to be selectively opened to allow for inflow of the sample (12) of the process from the transport line (14) into the first container (16), and to displace the displacement fluid (17) from the container due to its immiscibility with the process fluid.

The first container further comprises an outlet valve (24) which is configured to be selectively opened to allow flow discharge the displaced displacement fluid, or closed to prevent discharge of the displacement fluid. The outlet valve (24) is detachably connected to a connection line (26) via a suitable fitting (28), such as quick-connect fitting.

The connection line (26) is connected to a flow control device (30) to control the flow rate of the displacement fluid from the first cylinder (16), and throttle the rate at which the sample (12) flows into the first cylinder depending on the size of the orifice of the flow control device, the pressure and/or the properties of the fluid.

The flow control device (30) is connected to an actuated valve (32) via connection line (34). The actuated valve (32) is movable between a closed position and an open position, and is connected to the inlet (18a) of the second container (18) via connection line (36). In the closed position, the actuated valve (32) prevents the flow of the displacement fluid into the second cylinder (18).

A level switch (38) in communication with outlet (18b) is positioned above the second cylinder (18) to monitor the level of the displacement fluid within the second cylinder (18).

When the volume of the displacement fluid reaches the capacity of the second cylinder (18), the level switch (38) transmits a signal to a controller (40) via line (42) to close the actuated valve (32).

A controller (40) is operatively connected to the sample inlet valve (22a), the flow valve (32), and the fluid level sensor (38). The dashed lines (42, 72 and 74) represent operative connections between respective components, which can be either wired or wireless connections, or a combination of wired or wireless connections.

The controller (40) is pre-programmed to turn the first inlet valve (22a) and the actuated valve (32) “on” to trigger filling of the first cylinder with the sample (12) and subsequent filling of the second cylinder (18) with the displaced displacement fluid, or “off” to stop filling of the first cylinder with the sample (12) and subsequent filling of the second cylinder (18) with the displacement fluid (17).

The controller can be programmed to open and close the sample inlet valve (22a) and the actuated valve (32) to alternate between their respective closed and open positions for pre-defined intervals, while the second cylinder is being filled with the displacement fluid.

An overflow backup subsystem comprising a mechanical float (46) comprising an air vent valve (48) is connected with the outlet (18b) via line (50) and is connected to reservoir (52) is via line (54).

A mechanical float (46) is provided to allow air/gas to vent freely into the atmosphere or into the reservoir (52) via line (54) during filling of the second cylinder (18), thereby ensuring that the rate of displacement fluid fill remains steady. The air vent valve (48) is provided to act as a backup shut off if a failure occurs with the controller (40), level switch (38), or actuated valve (32).

A drain line (60) is connected to the second connection line (36) via a three-way solenoid valve (62) in order to direct the flow of the displacement fluid either into the second cylinder (18) or from the second cylinder (18) into a drain vessel (58) through a drain valve (56), as required.

The drain valve (56) can be selectively opened to drain the displacement fluid from the second cylinder (18) into a suitable vessel (58) via line (60), or closed to prevent drainage of the displacement fluid. The drain valve (56) can be operated manually or by controller 40 connected via operative connection 72.

A mechanical float (46) allows vapor to re-enter the second cylinder (18) automatically through line (54) as the displacement fluid is being drained from the second cylinder (18) in order to prevent a vacuum from forming and impeding the gravity drain from the second cylinder (18).

In operation, the operator manually opens the sample inlet valve (22b) and the sample outlet valve (24) to prepare the first cylinder for sampling. The operator can then step away from the system (10) which is thereafter controlled automatically by the controller (40). The controller opens the first inlet valve (22a) and the actuated valve (32) to allow the flow of the sample (12) from the transport line (14) into the first cylinder via the sample inlet line (20). The sample (12) displaces the displacement fluid (17) which flows through the outlet valve (24) into the connection line (26) to reach the flow control valve (30), which controls the flow rate of the displacement fluid from the first cylinder (16), and allows the flow of the displaced displacement fluid at a controlled rate into the second cylinder (18) via the second displacement fluid line (36).

The level switch (38) monitors the level of the displacement fluid within the second cylinder (18). When the volume of the displacement fluid reaches the capacity of the second cylinder (18), the level switch (38) transmits a signal to the controller (40) via line (42) to close the actuated valve (32) and the sample inlet valve (22a). Closure of these valves stops filling of the first cylinder with the sample (12) and subsequent filling of the second cylinder (18) with the displaced displacement fluid.

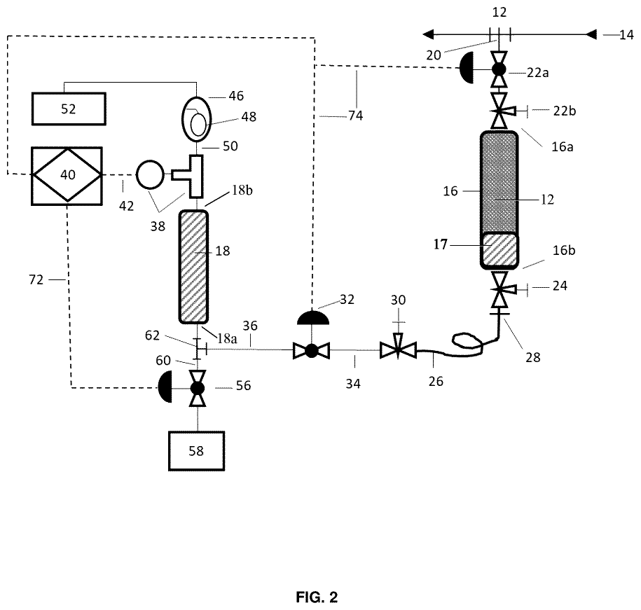

FIG. 2 is a schematic depiction of an embodiment of the system (10) of the present invention after the completion of the collection cycle.

Once the filling cycle has been completed, the operator can close the sample inlet valve (22b) and the sample outlet valve (24) and safely remove the first cylinder containing the collected sample (12) for analysis in the laboratory. A new cylinder can be connected in place of the first cylinder (16), and pre-filled with fresh or recycled displacement fluid.

The displacement fluid is emptied from the second cylinder (18) by opening the drain valve (56) or can be recycled to the new cylinder. Once the second cylinder (18) has been fully emptied, the system (10) is ready for the next sampling cycle.

Although the invention has been described with reference to certain specific embodiments, various modifications thereof will be apparent to those skilled in the art without departing from the spirit and scope of the invention. All such modifications as would be apparent to one skilled in the art are intended to be included within the scope of the following claims.

1. A system for collection of a sample of a process fluid flowing through a transport line, comprising:
a first container having an inlet and an outlet, said container being configured for a removable connection to the transport line to be in fluid communication therewith via said inlet, said first container being pre-filled with a displacement fluid immiscible with the process fluid;
a second container having an inlet in fluid communication with the outlet of the first container via a connection line removably connected to the outlet of the first container; said second container having a smaller volume than a volume of the first container;
a first sample inlet valve positioned between the inlet of the first container and the transport line, said sample inlet valve movable between a closed position and an open position;
an actuated valve positioned in the connection line between the outlet of the first container and the inlet of the second container, said actuated valve movable between a closed position and an open position;
a fluid level sensor configured to monitor a fluid level of the second container;
a controller operatively connected to said sample inlet valve, said flow valve, and said fluid level sensor,
said controller being configured to actuate the sample inlet valve and the actuated valve to move into their respective open positions to allow collection of the sample in the first container and transfer of the displacement fluid from the first container into the second container, and to actuate the sample inlet valve and actuated valve back to their respective closed positions upon receiving a signal from the fluid level sensor when the second container is filled with the displacement fluid.

2. The system of claim 1, further comprising a displacement fluid removal subsystem for removing the displacement fluid from the second container after collection of the sample in the first container.

3. The system of claim 2, wherein the displacement fluid removal subsystem comprises a drain line in communication with the second container via one or more drain valves, said drain valves movable between a closed position and an open position.

4. The system of claim 2, wherein the displacement fluid removal subsystem comprises a pump for pumping the displacement fluid to a replaced first container.

5. The system of claim 1, wherein the first container further comprises an outlet valve in communication with the connection line, said outlet valve movable between a closed position and an open position.

6. The system of claim 1, further comprising a second sample inlet valve positioned between the first inlet valve and the inlet of the first container, said valve movable between a closed position and an open position.

7. The system of claim 1, further comprising a flow control device in fluid communication with the actuated valve and the outlet of the first container for controlling flow rate of the displacement fluid.

8. The system of claim 1, wherein said fluid level sensor is a level switch, a pressure sensor or a pressure switch.

9. The system of claim 1, further comprising an overflow backup subsystem in communication with the second container, said overflow backup subsystem comprises a reservoir, a mechanical float comprising an air vent valve, or a combination thereof.

10. The system of claim 1, wherein, following initial opening of the sample inlet valve and the flow control valve and prior to the second container being filled with the displacement fluid, said controller is further configured to actuate the sample inlet valve and flow valve to alternate between their closed and open positions for pre-defined time intervals.

11. A method for collection of a sample of a process fluid flowing through a transport line, comprising:
providing a first container pre-filled with a displacement fluid immiscible with the sample;
providing a second container having a smaller volume than the first container, and configured to be in fluid communication with first container;
connecting the first container with the transport line;
allowing the process fluid to enter the first container to displace the displacement fluid and transfer same to the second container;
monitoring the level of the displacement fluid within the second container using a fluid level sensor,
stopping the flow of the process fluid into the first container and the flow of the displacement fluid into the second container upon receiving a signal from the fluid level sensor.

12. The method of claim 11, further comprising controlling a flow rate of the displacement fluid.

13. The method of claim 11, further comprising replacing the first container, and removing the displacement fluid from the second container.

14. The method of claim 11, comprising intermittently stopping the flow of the process fluid and displacement fluid for pre-defined internals while the second container is being filled.
